(19) United States
(12) Patent Application Publication
(10) Pub. No.: US 2019/0213613 A1
(43) Pub. Date: Jul. 11, 2019

(54) SEGMENTING MARKET DATA

(71) Applicant: Information Resources, Inc., Chicago, IL (US)

(72) Inventor: Norbert O. Schumacher, Chicago, IL (US)

(21) Appl. No.: 15/865,777

(22) Filed: Jan. 9, 2018

(51) Int. Cl. G06Q 30/02; G06F 7/58

(52) U.S. Cl. CPC G06Q 30/0204; G06F 7/588

(57) ABSTRACT

Transaction data is fit to a Dirichlet-multinomial distribution in order to estimate the manner in which various product attributes impact consumer purchasing behavior. In particular, the statistical parameters of the distribution can yield an empirical switching constant for each attribute that characterizes the significance of that attribute to purchasing decisions. The market data can be automatically and iteratively segmented based on a product attribute having the lowest switching constant until a stopping condition is reached, such as a condition based on whether a currently selected attribute has a measurable effect on consumer choice.

### TECHNICAL FIELD

This document relates to market data segmentation, and more particularly to systems and methods for determine a market structure by segmenting market data based on consumer product choices.

### BACKGROUND

Market participants often have access to sales data reflecting the details of consumer transactions in a particular product or market. This data may include details on product attributes such as brand names, stock keeping unit (“SKU”) numbers, time, location, price, volume, packaging, and so forth. Even with a large data set based on high transaction volumes, and sometimes due to the large size of a data set, it can be difficult to determine how different attributes affect consumer purchasing decisions.

One model commonly used in marketing research is the Hendry model, which provides an iterative, trial-and-error approach to identifying market structure. As a significant disadvantage, the Hendry model can require significant use of judgement and manual revision to yield a good fit to empirical data, and may be susceptible to a variety of system biases reported in academic literature. In response to these perceived deficiencies, other techniques have emerged. However, more recent techniques still appear to require significant judgement and manual revision to arrive at acceptable results. For example, current techniques may rely on manual selections or estimates of market structure to initiate an analysis, and/or iterative post hoc evaluations of statistical measures of fit to determine whether a particular model properly describes the structure of a market.

There remains a need for improved techniques to infer consumer preferences based on transaction data, and more particularly for techniques to model market structure based on transaction data in a fully automated manner without the need for human input or guidance.

### SUMMARY

Transaction data is fit to a Dirichlet-multinomial distribution in order to estimate the manner in which various product attributes impact consumer purchasing behavior. In particular, the statistical parameters of the distribution can yield an empirical switching constant for each attribute that characterizes the significance of that attribute to purchasing decisions. The market data can be automatically and iteratively segmented based on this empirical switching constant until a suitable stopping condition is reached, such as a condition based on whether a further segmentation continues to meaningfully describe consumer choices.

### BRIEF DESCRIPTION OF THE FIGURES

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows a market analytics network environment.

FIG. 2 illustrates a computing system.

FIG. 3 is a flowchart of a method for segmenting market data.

FIG. 4A is a table listing an exemplary unsegmented data set.

FIG. 4B is an exemplary output structure.

FIG. 5 is a table listing an exemplary unsegmented data set.

FIGS. 6A, 6B and 6C are tables listing oriented data sets.

FIG. 7 is a table reflecting a shuffle matrix.

FIG. 8 is a table listing an oriented data set for a randomized data set.

FIG. 9 is a generational decision tree.

FIG. 10 is a table listing an exemplary unsegmented data set.

FIGS. 11A and 11B are tables listing oriented data sets.

FIG. 12 is a generational decision tree.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated or otherwise clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values or ranges of values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “third,” “above,” “below,” and the like, are words of convenience and are not to be construed as limiting terms unless expressly state otherwise.

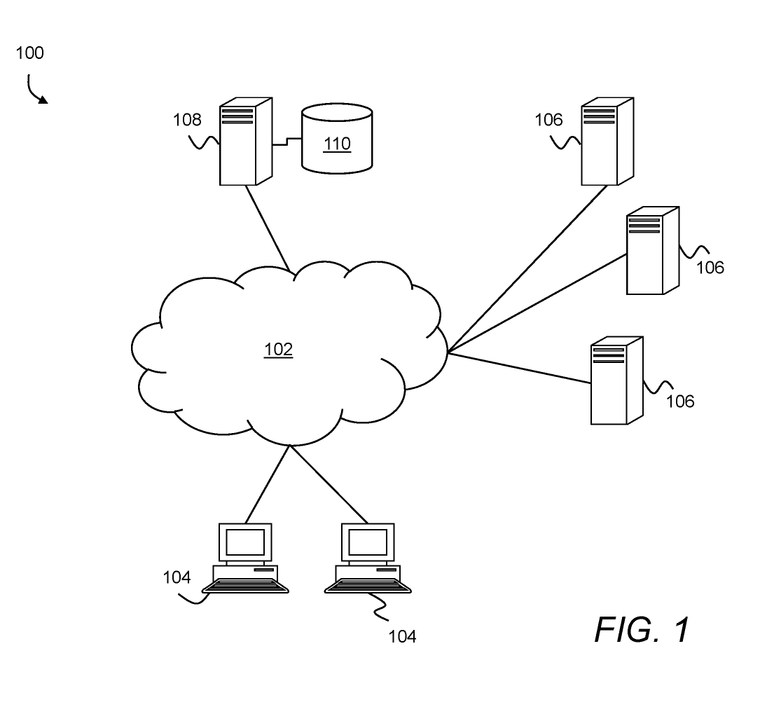

FIG. 1 shows a system environment for segmenting market data. The system 100 may include a data network 102 such as the Internet that interconnects any number of clients 104, data sources 106, and servers 108 (each of which may include a database 110). In general, the server 108 may obtain data from the various data sources 106 and provide a user interface to clients 104 for creating and using models based on data from the data sources 106.

The data network 102 may include any network or combination of networks suitable for interconnecting other entities as contemplated herein. This may, for example, include the Public Switched Telephone Network, global data networks such as the Internet and World Wide Web, cellular networks that support data communications (such as 3G, 4G and LTE networks), local area networks, corporate or metropolitan area networks, wide area wireless networks and so forth, as well as any combination of the foregoing and any other networks suitable for data communications between the clients 104, data sources 106 and the server 108.

The clients 104 may include any device operable by end users to interact with the servers 108 and data sources 106 through the data network 102. This may, for example, include a desktop computer, a laptop computer, a tablet, a cellular phone, a smart phone, and any other device or combination of devices similarly offering a processor and communications interface collectively operable as a client device within the data network 102. In general, a client 104 may interact with the server 108 and locally render a user interface such as a web page or the like for a user to access services hosted by the server 108. This may include a variety of data analytics and data management tools, as well as administrative tools for creating accounts, controlling access to data, and so forth. The servers 108 may also support interaction by an end user with the data sources 106 or related services provided by the server 108.

The data sources 106 may include any sources of data for tracking, storing, or analyzing consumer transactions or purchasing behavior, such as any of the various sources of data described herein, or any other useful sources of information. Examples of data that may be included in the data sources 106 include, without limitation, panel data, display audit data, point of sale data, trade area data, store data, and the like. It will be appreciated that in general such data may be stored in the data sources 106 remote from one of the servers 108, or stored in a database 110 local to one of the servers 108, or some combination of these, all of which are generally referred to herein as a database. In general, the physical and logical arrangement of such a database may be in any form, and one of the servers 108 may provide a seamless interface to such data in any suitable format. A variety of potential data sources are discussed in greater detail below.

The server 108 may include any number of physical or logical machines according a desired level of service, scalability, processing power or any other design parameters. In general, the server 108 may be configured to gather data from data sources 106 and process the data to create models such as those contemplated herein. In addition, the server 108 may provide a programming interface for creating and modifying models, a user interface for using the models, and an administrative interface for managing models, data, data access, user accounts, and so forth, as well as any other tools or interfaces suitable for creating or interacting with models as contemplated herein. In one aspect, the server 108 may include a number of separate functional components (which may be similarly logically or physically separated, or embodied in a single machine) such as one server coupled to the data sources 106 for managing communications therewith, such as through an application or database programming interface, a second server that provides a user interface to clients 104, and a third server that provides statistical engines and the like for creating and using models based on the data.

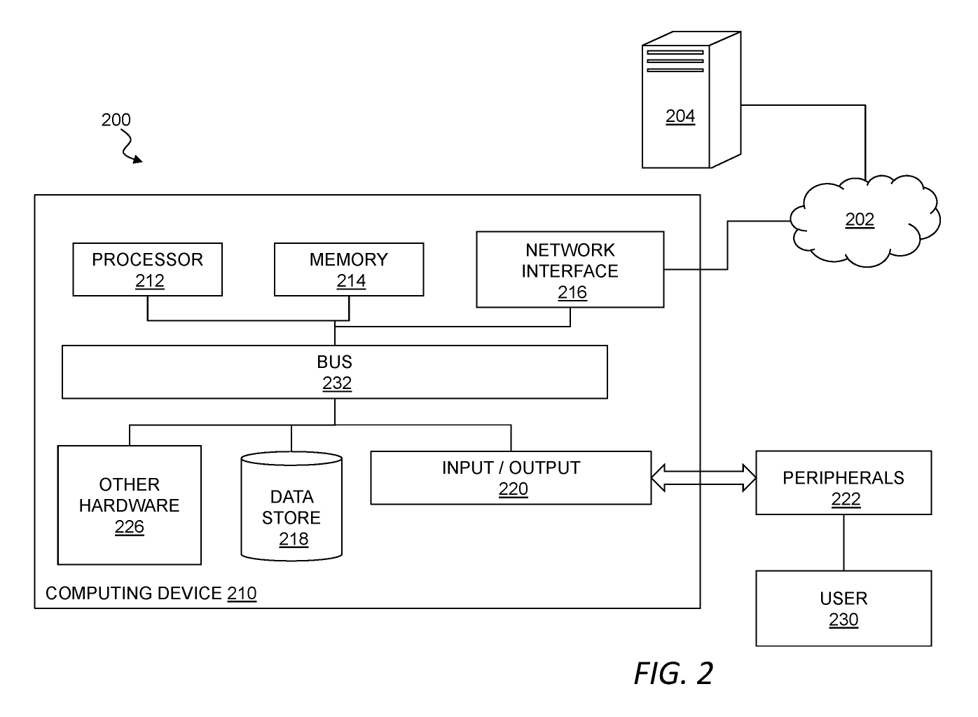

FIG. 2 illustrates a computer system 200. In general, the computer system 200 may include a computing device 210 connected to an external device 204 through a network 202. The computing device 210 may be or may include any of the network entities described above including data sources, servers, client devices, and so forth. For example, the computing device 210 may include a desktop computer workstation. The computing device 210 may also or instead be any device suitable for interacting with other devices over a network 202, such as a laptop computer, a desktop computer, a personal digital assistant, a tablet, a mobile phone, a television, a set top box, a wearable computer, and the like. The computing device 210 may also or instead include a server such as any of the servers described above. The computing device 210 may be a standalone physical device, a device integrated into another entity or device, a platform distributed across multiple entities, or a virtualized device executing in a virtualization environment.

The network 202 may include any of the networks described above, e.g., data network(s) or internetwork(s) suitable for communicating data and control information among participants in the computer system 200.

The external device 204 may be any computer or other remote resource that connects to the computing device 210 through the network 202. This may include any of the servers or data sources described above, as well as any other peer device, client device, server device, network resource or other device or combination of devices that might usefully be connected in a communicating relationship with the computing device 210 through the network 202.

In general, the computing device 210 may include a processor 212, a memory 214, a network interface 216, a data store 218, and one or more input/output interfaces 220. The computing device 210 may further include or be in communication with peripherals 222 and other external input/output devices that might connect to the input/output interfaces 220.

The processor 212 may be any processor or other processing circuitry capable of processing instructions for execution within the computing device 210 or computer system 200. The processor 212 may include a single-threaded processor, a multi-threaded processor, a multi-core processor and so forth, as well as combinations of these. The processor 212 may be capable of processing instructions stored in the memory 214 or the data store 218.

The memory 214 may store information within the computing device 210. The memory 214 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 214 may store program instructions, program data, executables, and other software and data useful for controlling operation of the computing device 210 and configuring the computing device 210 to perform functions for a user. The memory 214 may include a number of different stages and types of memory for different aspects of operation of the computing device 210. For example, a processor may include on-board memory and/or cache for faster access to certain data or instructions, and a separate, main memory or the like may be included to expand memory capacity as desired. All such memory types may be a part of the memory 214 as contemplated herein.

The memory 214 may, in general, include a non-volatile computer readable medium containing computer code that, when executed by the computing device 210 creates an execution environment for one or more computer programs including, e.g., code that constitutes processor firmware, a protocol stack, a database management system, an operating system, or a combination of the foregoing, and that performs some or all of the steps set forth in the various flow charts and other algorithmic descriptions set forth herein. While a single memory 214 is depicted, it will be understood that any number of memories may be usefully incorporated into the computing device 210. For example, a first memory may provide non-volatile storage such as a disk drive for permanent or long-term storage of files and code even when the computing device 210 is powered down. A second memory such as a random-access memory may provide volatile (but higher speed) memory for storing instructions and data for executing processes. A third memory may be used to improve performance by providing higher speed memory physically adjacent to the processor 212 for registers, caching and so forth.

The network interface 216 may include any hardware and/or software for connecting the computing device 210 in a communicating relationship with other resources through the network 202. This may include remote resources accessible through the Internet, as well as local resources available using short range communications protocols using, e.g., physical connections (e.g., Ethernet), radio frequency communications (e.g., Wi-Fi), optical communications, (e.g., fiber optics, infrared, or the like), ultrasonic communications, or any combination of these or other media that might be used to carry data between the computing device 210 and other devices. The network interface 216 may, for example, include a router, a modem, a network card, an infrared transceiver, a radio frequency (RF) transceiver, a near field communications interface, a radio-frequency identification (RFID) tag reader, or any resource for transceiving data or otherwise managing communications with other devices.

The data store 218 may be any internal memory store providing a computer-readable medium such as a disk drive, an optical drive, a magnetic drive, a flash drive, or other device capable of providing mass storage for the computing device 210. The data store 218 may store computer readable instructions, data structures, program modules, and other data for the computing device 210 or computer system 200 in a non-volatile form for relatively long-term, persistent storage and subsequent retrieval and use. For example, the data store 218 may store an operating system, application programs, program data, databases, files, and other program modules or other software objects and the like.

The input/output interface 220 may support input from and output to other devices that might couple to the computing device 210. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for wirelessly coupling in a communicating relationship with other local devices. It will be understood that, while the network interface 216 for network communications is described separately from the input/output interface 220 for local device communications, these two interfaces may be the same, or may share functionality, such as where a USB port is used to attach to a Wi-Fi accessory, or where an Ethernet connection is used to couple to a network attached storage device.

The peripheral 222 may include any device used to provide information to or receive information from the computing device 200. This may include human input/output (I/O) devices such as a keyboard, a mouse, a mouse pad, a track ball, a joystick, a microphone, a foot pedal, a camera, a touch screen, a scanner, or other device that might be employed by the user 230 to provide input to the computing device 210. This may also or instead include a display, a speaker, a printer, a projector, a headset or any other audiovisual device for presenting information to a user. The peripheral 222 may also or instead include a digital signal processing device, an actuator, or other device to support control of or communication with other devices or components. Other I/O devices suitable for use as a peripheral 222 include haptic devices, three-dimensional rendering systems, augmented-reality displays, and so forth. In one aspect, the peripheral 222 may serve as the network interface 216, such as with a USB device configured to provide communications via short range (e.g., Bluetooth, Wi-Fi, Infrared, RF, or the like) or long range (e.g., cellular data or WiMax) communications protocols. In another aspect, the peripheral 222 may augment operation of the computing device 210 with additional functions or features, such as a global positioning system (GPS) device, a security dongle, or any other device. In another aspect, the peripheral 222 may include a storage device such as a flash card, USB drive, or other solid-state device, or an optical drive, a magnetic drive, a disk drive, or other device or combination of devices suitable for bulk storage. More generally, any device or combination of devices suitable for use with the computing device 200 may be used as a peripheral 222 as contemplated herein.

Other hardware 226 may be incorporated into the computing device 200 such as a co-processor, a digital signal processing system, a math co-processor, a graphics engine, a video driver, a camera, a microphone, speakers, and so forth. The other hardware 226 may also or instead include expanded input/output ports, extra memory, additional drives (e.g., a DVD drive or other accessory), and so forth.

A bus 232 or combination of busses may serve as an electromechanical backbone for interconnecting components of the computing device 200 such as the processor 212, memory 214, network interface 216, other hardware 226, data store 218, and input/output interface. As shown in the figure, each of the components of the computing device 210 may be interconnected with a system bus 232 and coupled in a communicating relationship through the system bus 232 for sharing controls, commands, data, power, and so forth.

Methods and systems described herein can be realized using the processor 212 of the computer system 200 to execute one or more sequences of instructions contained in the memory 214 to perform predetermined tasks. In embodiments, the computing device 200 may be deployed as a number of parallel processors synchronized to execute code together for improved performance, or the computing device 200 may be realized in a virtualized environment where software on a hypervisor or other virtualization management facility emulates components of the computing device 200 as appropriate to reproduce some or all of the functions of a hardware instantiation of the computing device 200.

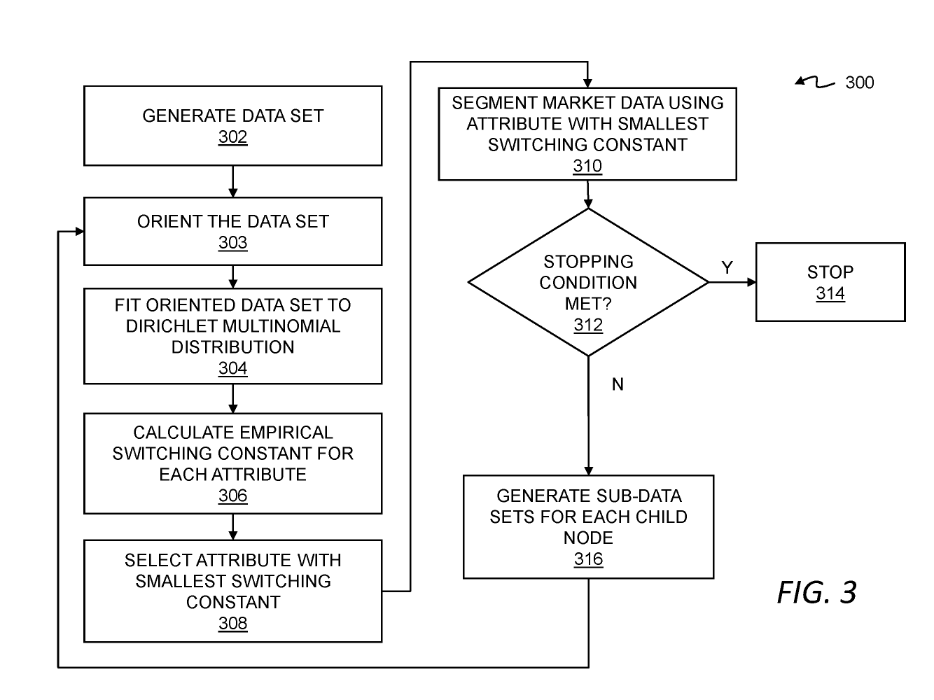

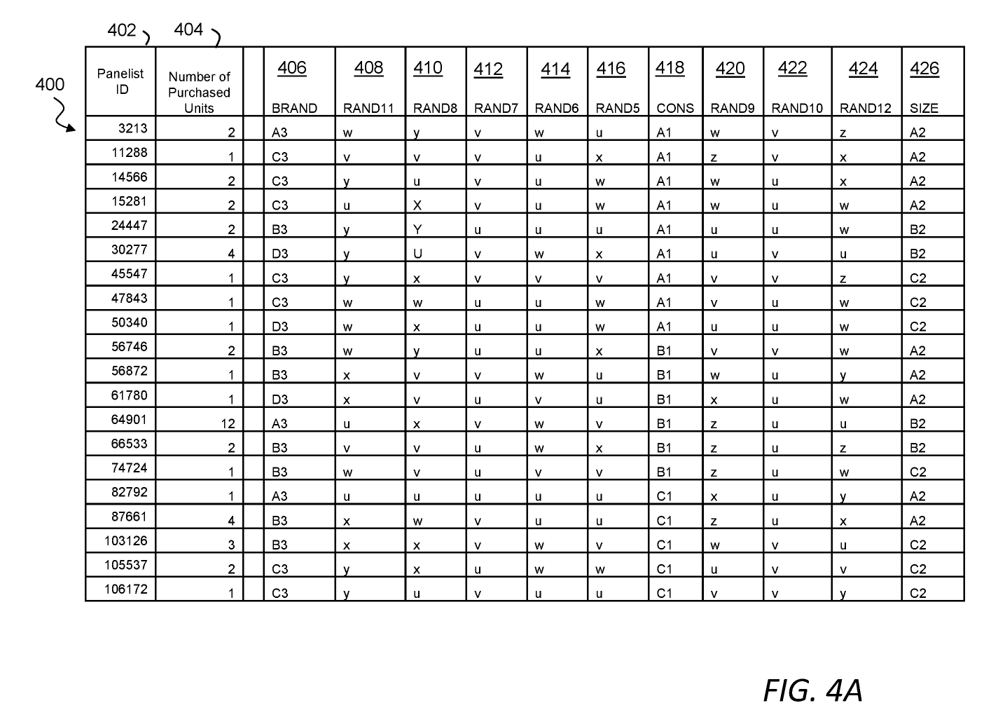

FIG. 3 is a flowchart of a method 300 for segmenting market data. The term “segmenting,” as used in reference to market data herein, may refer to any technique for organizing or sorting transactional data based on the significance of attributes to a purchaser as expressed in consumer purchasing decisions. The illustrative method 300 is described below and may be more fully-understood in the context of the following disclosure, particularly in conjunction with additional examples described and shown in FIGS. 4-12.

It may be desirable for market participants to know not only which attributes of a product are significant, but also which attributes are more significant than others, and in what order a consumer may rank those attributes, either explicitly, or implicitly through purchasing decisions. For example, a sequence of mental choices made by a consumer may determine the relevance of the various attributes selected. There is value in knowing that when purchasing laundry detergent, for example, the fragrance of the detergent is more important to a consumer than the color of the packaging or any other attribute associated with laundry detergent (e.g., size, brand, additives, price or the like). Raw transactional data collected from purchasers or panel participants may reflect that detergent with blue packaging, for example, was purchased a certain number of times and detergent with red packaging was purchased a certain number of times. The raw data, however, fails to give any indication of how important that attribute (blue or red packaging) is to the consumer, especially when compared to other attributes of the product, such as fragrance or package size. This can become particularly complicated when color is partially, but not wholly correlated to brand or some other attribute for a product.

In general, the significance of any given attribute may lie on a continuum from very significant to virtually meaningless. That is, a given product attribute need not be characterized merely as a binary choice of “significant” or “insignificant.” For example, while the color of the packaging of a given product may not be very relevant to consumers, attributes such as volume, brand, price per liquid ounce and the like may be of greater significance, and these various attributes may suggest a model or market structure that characterizes the level of significance of these attributes to the consumer, and/or the effect of these attributes on purchasing behavior. A market participant, such as a manufacturer, distributor, brand manager, or any other entity involved in the development, marketing or sale of a product, may wish to identify the relevance of certain product attributes according to the explicit or implicit order of attribute choices made during a purchase. Segmenting market data may provide an output structure (used herein to refer to any market structure, consumer choice model, or similar data structure or the like that describes the relationship between product attributes and consumer behavior) that is indicative of the absolute and comparative relevance of those attributes to consumers when making choices.

It should also be appreciated that many attributes may describe a range of characteristics. For example, product price, package size, weight, calories, and so forth may have numerical values falling across a continuous range of possible values. For these types of attributes, various ranges of values may be used to define bins that can be used as discrete product attributes.

As described herein, the Dirichlet-Multinomial distribution may be employed to model a number of purchases and to investigate a market structure for attribute-based consumer purchasing decisions reflected within those purchases. While the literature varies, the density function for a Dirichlet-Multinomial Distribution may be expressed as:

$$f ( \vec{x} ) = \frac{n ! Γ ( {\sum }_{j = 1}^{J} {α}_{j} )}{Γ ( n + {\sum }_{j = 1}^{J} {α}_{j} )} {\prod }_{j = 1}^{J} \frac{Γ ( {x}_{j} + {α}_{j} )}{{x}_{j} ! Γ ( {α}_{j} )} \qquad [ Eq . 1 ]$$

For an attribute-based market segmentation, an empirical switching constant k_{we} may be expressed as:

$${α}_{j} = \frac{{k}_{w}}{1 - {k}_{w}} {p}_{j} \qquad [ Eq . 2 ]$$

By substitution:

$$S = {\sum }_{j = 1}^{J} {α}_{j} = \frac{{k}_{w}}{1 - {k}_{w}} = {α}_{0} = \frac{1 - θ}{θ} \qquad [ Eq . 4 ]$$

For this expression of the density function for the Dirichlet-Multinomial distribution, a dispersion parameter may be expressed as:

$$f ( \vec{x} ) = \frac{n ! Γ ( \frac{{k}_{w}}{1 - {k}_{w}} )}{Γ ( n + \frac{{k}_{w}}{1 - {k}_{w}} )} {\prod }_{j = 1}^{J} \frac{Γ ( {x}_{j} + \frac{{k}_{w}}{1 - {k}_{w}} {p}_{j} )}{{x}_{j} ! Γ ( \frac{{k}_{w}}{1 - {k}_{w}} {p}_{j} )} \qquad [ Eq . 3 ]$$

This general framework may be employed to analyze transactional data and identify attribute-based purchasing patterns. In general, several statistical tools are available to assist in the analysis of data based on the Dirichlet-Multinomial distribution as contemplated herein. One such platform is the “R system,” an open-source software language and run-time environment offered by the Comprehensive R Archive Network. In one aspect, systems, methods and computer program products described herein may use statistical computation packages from the R system to execute statistical calculations. One of ordinary skill in art will recognize, that while certain aspects of the invention are described herein using the R system and certain of its function packages, that the invention is not limited to the use of a particular software or statistical computation package. Other statistical analysis tools are available that provide similar or identical functionality, any of which may be used to assist in analysis according to the present disclosure.

In one aspect, a data segmenting tool for performing the method 300 may be implemented to create, intake, orient, and analyze market transaction data and generate an output structure reflective of segmented market data. One such output structure may take the form of a generational decision tree, where each branch, or child node, of the tree represents an ordered attribute choice made by a consumer when purchasing a product.

The data segmenting tool may be realized as a computer program product comprising computer-executable code or computer-usable code and embodied in a non-transitory computer readable medium that, when executed on a computer, performs some or all of the steps described herein. In another aspect, a computer may be configured to perform the steps described herein.

As shown in step 302, the method 300 may include generating a data set. In general, the data set may contain market data or transactional data describing purchases of a product type or purchases within a certain market. The method 300 may include generating a first data set comprising market data describing transactions in each of a plurality of products based on, e.g., observations of actual purchases or other transactions. Each product may be characterized by a number of attributes having a corresponding number of values. The market data may further include, for each transaction or a group of transactions, a unique identifier representing a particular consumer associated with the transaction(s) and the number of transactions for a product. The market data may also or instead include several attributes common to the various products within the product type. For example, if laundry detergent is the given product type to be investigated, the market data may comprise data reflecting a customer identifier, the number of transactions made by the customer in buying laundry detergent and various attributes such as consistency (e.g., powder, liquid, pod-based), package size (e.g., small, medium, large), and brand (e.g., a company or brand name for the product).

As shown in step 303, the method 300 may include orienting the data sets. The data segmenting tool may receive, access, or generate the raw data, and may convert or reformat the raw data into suitable data sets for analysis. In one aspect, the data segmenting tool may re-reorient the raw data into oriented data sets having a common attribute. That is, the raw data may be organized by the unique customer ID into separate, oriented data sets for each attribute, with additional columns representing the attribute choices of the product type. For example, in a laundry detergent data set with three attributes (e.g., consistency, size and brand), three oriented data sets may be formed using the unique customer ID as the index or sorting data point. Each oriented data set may, for example, contain the same information as the other data sets, while being organized around a selected one of the attributes.

As shown in step 304, the method 300 may include fitting each of the oriented data sets to a Dirichlet-multinomial distribution (“DM distribution”). In general, a DM distribution is a probability distribution for describing the outcomes of a multinomial experiment. The DM distribution is known to be useful in several fields reliant on statistics and probabilities, such as genetics (allele frequency in different subpopulations), document classification (latent Dirichlet allocation), and marketing (analyzing multivariate choices). As further detailed below, the parameters of the DM distribution for a given product attribute may be used to evaluate the relative importance of a product attribute in a purchasing decision. In particular, overdispersion within the DM distribution characterizes a departure of the DM distribution from a Multinomial distribution, and reflects the degree to which data within the distribution deviates from otherwise random purchasing behavior. Thus, the overdispersion of a category or attribute within a DM distribution of transactional data, which can be derived for example from the covariance matrix for the distribution, implies a non-random order of selection based on that attribute, which, in the context of market data, can provide useful inferences relative to consumer behavior, particularly a non-random preference for or against the corresponding attribute. One such measure derived from the overdispersion within the DM distribution is referred to herein as an empirical switching constant k_{we}, which can be used to numerically describe a tendency to make a decision based on the attribute for which the switching constant is calculated. It will be appreciated that, while the empirical switching constant may usefully be calculated using an estimation function based on the covariance matrix for one of the attributes as described herein, any other measure of overdispersion, or any other metric otherwise representative of non-randomness of selection order, may also or instead be used.

In one aspect, the data segmenting tool may provide a technical advantage over known market segmenting techniques by using the market data to calculate an empirical value of a switching constant k_{we} indicative of customer loyalty to a given product attribute. Prior market segmenting approaches rely on theoretical values of the switching constants k_{wt} as well other human-based judgments in attempting to segment market data into an ordered hierarchy of consumer choices. These existing approaches tend to require substantial initial judgement to select suitable values, along with substantial post hoc review to determine whether the resulting model(s) adequately describe the data. As a significant advantage, the techniques described herein are amenable to direct and deterministic implementation as an automatic process, and can achieve an objectively accurate market segmentation without significant human intervention.

As shown in step 306, the method 300 may include calculating an empirical switching constant k_{we} for each attribute. In general, the market segmenting tool may calculate the empirical switching constant based on the Dirichlet multinomial distribution. Each empirical switching constant may be indicative of a significance of one of the number of attributes in a consumer decision relating to a purchase of one of the plurality of products. In one aspect, the statistical parameters of the DM distribution characterize the dispersion or overdispersion for a given product attribute. An overdispersion parameter, referred to herein as ‘0’, may indicate a degree of greater variability in a data set than would be expected based on a given statistical model and random choices or outcomes, in this case for the DM distribution. The overdispersion of a DM distribution, for a given attribute, indicates of the relevance of a corresponding attribute in the consumer's choice of a product. For example, a distribution having an overdispersion of zero (0) may indicate that the distribution is completely random (i.e., the data set does not vary from a random distribution). Conversely, an overdispersion of one (1) may indicate that the data is completely structured or lacks randomness (i.e., the data set varies greatly from what one would expect based on a random distribution). Thus, a distribution having a high overdispersion may indicate that the product attribute being investigated has significance to the consumer and is not chosen at random.

In one aspect, the overdispersion parameter θ of a DM distribution may be calculated with an estimation function using a method of moments estimation. The method of moments is a known method for estimating the parameters of a probability distribution, such as a DM distribution. In one aspect, the overdispersion parameter θ for each DM distribution (relating to each attribute choice of a product type) may be calculated using the R system and an add-on function package, ‘dirmult.’ The dirmult package for the R system, written by Torben Tvedebrink and obtainable from the open-source, Comprehensive R Archive Network repository, contains functions and computational code for estimating parameters in DM distributions. One such function, entitled ‘weirMoM’ estimates the overdispersion parameter θ using a method of moments estimate developed by Weir, B. S. and W. G. Hill (“Estimating F-statistics” (2002) Ann. Rev. Genet. 36: 721-750.) While a method of moments estimation is disclosed herein, one of ordinary skill in the art will recognize that other parameter estimation techniques may also or instead be used to evaluate the overdispersion of a DM distribution as contemplated herein. For example, a maximum likelihood estimate may be used to yield similarly effective results, particularly when the sample sizes are large.

The data segmenting tool may use the overdispersion parameter θ of a DM distribution for a product attribute to further calculate the empirical switching constant k_{we}. In one aspect, the empirical switching constant k_{we} is calculated as: k_{we}=1-0. Thus, if an empirical switching constant k_{we} is equal to 0 (an overdispersion of 1), the data may reflect customers as completely loyal to the given product attribute. An empirical switching constant k_{we} equal to 1 (an overdispersion of 0) may represent complete customer disloyalty and customers choosing randomly among the given product attribute.

In one aspect, the data segmenting tool may calculate the empirical switching constant k_{we} for each attribute being considered in the data set. Returning to the laundry detergent example, the data segmenting tool, given the three oriented data sets for consistency, size and brand, sorted by unique customer number, may calculate the overdispersion parameters (θ) for each attribute, and thus determine an empirical switching constant k_{we} for each of the consistency, size and brand attributes.

As shown in step 308, the method 300 may include selecting the attribute with the smallest empirical switching constant. The data segmenting tool may compare each of the empirical switching constants for each of the attributes and select the attribute with the lowest empirical switching constant k_{we} as the attributed to be used for segmenting the market data. As described above, the attribute with the lowest empirical switching constant k_{we} may generally represent the attribute with the greatest significance to the consumer when choosing the product (e.g., the most important attribute identified by the consumer when choosing a particular product within the given product type.)

As shown in step 310, method 300 may include segmenting the market data using the selected attributed, e.g., the attribute determined to have the lowest empirical switching constant k_{we}. In general, the market segmenting tool may segment the market data into child nodes using a first attribute from the available attributes that is associated with the lowest switching constant. To segment the market data, the attribute found to have the smallest empirical switching constant k_{we} is identified at the first generation of a generational decision tree, with child nodes reflecting each of the attribute choices or values available for that attribute.

As described below, these first-generation child nodes represent the most significant choice among consumers when buying the given product type. For example, continuing with the detergent example (and as further detailed below in conjunction with FIGS. 4A and 4B), if the consistency attribute is found to be the most significant attribute, child nodes representing each available consistency choice (powder, liquid or pod-based) may form the first generation of the generational decision tree and the source market data may be divided into a number of separate segments, each representing one of the attribute values. Thus, referring again to the consistency example, the data may be segmented into a first data set consisting of transactions for detergent in powder form, a second data set consisting of transactions for detergent in liquid form, and a third data set consisting of transactions for detergent sold as pods. As described below, additional generations and child nodes, reflecting the remaining product attributes (e.g., size and brand), may be added to the output structure for each of these separate segments or data sets if the result is deemed to be statistically relevant.

As shown in step 312, the method 300 may include determining if a stopping condition is met. Any of a variety of stopping conditions may be used, and the stopping condition may be met under any number of circumstances. For example, the stopping condition may be a static stopping condition such as reaching the last of the available attributes, segmenting the data according to some predetermined number of attributes, or segmenting the data until a predetermined number of attributes remain. In another aspect, the stopping condition may be a dynamic stopping condition, e.g., that varies according to the current results, such as by segmenting the data until the resulting data sets reach a certain minimum size.

In one aspect, the stopping condition may by statistically based, such as by segmenting the data until further segmentation does not result in a market structure indicating attributes that are statistically significant to the consumer. In order to apply such a stopping condition, the data segmenting tool may assess the statistical significance of an attribute being investigated by comparing the empirical switching constant k_{we} to a mean of randomized switching constants k_{wr} calculated under a null-hypothesis (i.e., a random shuffling of the attribute values). The data segmenting tool may randomize the values for the given attribute a predetermined number of times to create a predetermined number of randomized data sets. The data segmenting tool, following the above procedure, may calculate the predetermined number of randomized switching constants k_{wr} for each of the randomized data sets to generate a randomized switching constant k_{wr} distribution. The data segmenting tool may further calculate the mean of the randomized switching constant k_{wr} distribution and compare the mean to the empirical switching constant k_{we}. In one aspect, if the empirical switching constant k_{we} is within a predetermined range (e.g., multiple) of the standard deviation (σ) of the mean (μ) of the randomized switching constant k_{wr} distribution, then the stopping condition is met and the iterative process may be stopped. If the empirical switching constant k_{we} is not within the predetermined multiple of the standard deviation of the mean of the randomized switching constant k_{wr} distribution, this implies that further statistically significant market segmentation can be performed on the data (or stated differently, that additional consumer preferences can be identified) and the stopping condition will not be met. In such a case, as shown in step 316, child nodes for that attribute may be added to the hierarchical decision tree reflecting sub-data sets for each of the attribute choices for that attribute.

As shown in step 314, the method 300 may include stopping if the stopping condition is met, indicating the output structure is complete. A notification may be provided to a user using any suitable communication medium, and the resulting model may be made available to project future sales or purchasing activity, or to analyze, predict or otherwise process market data as desired. Alternatively, if the stopping condition is not met, the method 300 may continue the analysis of the sub-data sets for each child node.

As shown in step 316, the method 300 may include generating sub-data sets for each child node. Each sub-data set may be characterized by a common value of the first attribute. In general, the market segmenting tool may generate sub-data sets for each child node with a common value. In the laundry detergent example, once the lowest empirical switching constant k_{we} is found among the three attributes, say consistency (CONS) a sub-data set may be formed by associating the transactions in which CONS was a chosen attribute. The method 300 may then return to step 303 where the sub-data set may be re-oriented into two data sets (SIZE, BRAND) according to the customer ID as described above, and a new lowest empirical switching constant k_{we} may be found among the two remaining attributes.

The method 300 may include iteratively perform the steps 303 through 316 until the stopping condition is met and the output structure is complete. In the case of a generational decision tree, the output structure may reflect the final hierarchical choices made by consumers of the relevant attributes analyzed and identified by the data segmenting tool. The method 300 may be more fully understood when described, as below, in additional detail using exemplary data sets as examples to illustrate a more tangible and technical result.

FIG. 4A is a table 400 showing an exemplary sample of an unsegmented data set. The unsegmented data set may reflect various data points associated with a purchased product type, including a Panelist ID column 302, a Number of Purchased Units column 304, and columns for eleven various attributes 406-426 associated with the type of product purchased. When market data is collected, each consumer participating, whether by polling, survey, panel data collection, or data extraction from collected transactional data, may be assigned a unique Panelist ID 402 to anonymize the data and any association between the data and the purchaser's personal information. The data contained in the Number of Purchased Units column 404 may reflect the number of times, given a defined time period that a consumer has purchased a certain product. The product type may be associated with several attributes that factor into a consumer's choice of which product to purchase. An example of such attributes is reflected in the table 400 by the labels BRAND 406, RAND11 408, RAND8 410, RAND7 412, RAND6 414, RAND5 416, CONS 418, RAND9 420, RAND10 422, RAND12 424 and SIZE 426. As further explained below, an illustrative analysis of the data set of the table 400 investigates three attributes, namely BRAND 406, CONS 418 and SIZE 426, although any number of such attributes may be used. The remaining attributes may be identified, tracked and used for other purposes, including more complex and deeper data segmentation operations, however for illustrative purposes, those attributes are denoted as “RANDX”. One skilled in the art will recognize that the attribute labels used here, and throughout, are merely exemplary and any suitable label or variable name may be used. One of ordinary skill in the art will also recognize that while only three attributes are analyzed in the following example, any number of attributes may be considered and analyzed using the systems, methods, and tools described herein.

The unsegmented data of the table 400 may reflect the raw or unsegmented data set related to the purchase of laundry detergent, for example. The columns of the table 400 represent preselected properties or choices common to the product of interest (e.g., a laundry detergent). For example, CONS 418 may reflect a choice of consistency (powdered, liquid or pod-based detergent). SIZE 426 may reflect the size or volume of the purchased detergent package, and BRAND 406 may reflect the actual brand name of the purchased detergent. The corresponding attribute values may be represented or encoded within each data set in any suitable manner. In this example, the values are identified by abstract identifiers such as “A1” or “C3”, however a full text descriptor, numerical identifier or other representation may also or instead be used. RAND5 through RAND12 may reflect any additional properties of detergent that purchasers might consider when making a purchasing decision, or any other properties that might otherwise be relevant to evaluating consumer behavior or market structure as contemplated herein.

FIG. 4B is an exemplary output structure 450. The data segmenting tool may generate the exemplary output structure 450 using the raw data given in the table 400 of FIG. 4A, and the methods and steps previously detailed herein. The output structure 450 may be in the form of a generational decision tree with child nodes reflecting the ordered choices made by a consumer when purchasing a product type 428, laundry detergent, for example. One of ordinary skill in the art will recognize that while the output structure 450 of the segmented market data is illustrated in the form of a hierarchical decision tree, other visualizations and structures that reflect the ordered attribute choices made by consumers may also or instead be employed without deviating from the aspects of the invention described herein.

In the example output structure 450 of FIG. 4B, the consistency attribute (A1:liquid, B1:powered, C1:pod-based) is the most significant choice to the consumer. In one aspect, the data segmenting tool may fit the transactional data from the table 400 of FIG. 4 to a DM distribution, and using the methods and steps described above, determine that the empirical switching constant k_{we} for the consistency attribute is lower than the empirical switching constants k_{we} for the other DM distribution attributes being investigated, such as size and brand. Once consistency has been selected, and if it is determined that a stopping condition has not been met, the next relevant attribute may be sought. After segmenting the data into data subsets according to consistency, data from each of the sub-data sets may further be re-oriented into two sub-data sets for size and brand. These segmented and re-oriented sub-data sets may then be fit to DM distributions as described above, and the data segmenting tool may calculate new empirical switching constants k_{we}. The data segmenting tool may determine empirical switching constants k_{we} for size and brand. In the illustrated example, the switching constants k_{we} for size is lower than the switching constants k_{we} for brand, indicating that the second most significant attribute to the consumer decisions is the size attribute (as illustrated, A2:Large, B2:Medium, C2: Small). With only three attributes under investigation, the data segmenting tool may indicate brand as the third most relevant attribute in the purchasing decision. The data sets may be further segmented according to brand and the processing may complete.

As detailed above, the data segmenting tool may iteratively operate on the raw data a predetermined number of times, or it may continue to analyze the raw data until it determines that the remaining attributes corresponding to the product type are not statistically relevant to the consumers purchase choice. That is, while the product chosen by the consumer may have different and distinguishing attributes from other available products, those attributes may be found to be statistically insignificant to consumers when choosing the product. Alternatively, as the data segmenting tool proceeds through the data, if additional features are found to be statistically significant and relevant to consumer choice, the process may continue to generate additional child nodes for the output structure 450 reflecting those attribute choices until all relevant attributes are reflected in the decision tree.

While the above example illustrates an output structure in which only three attributes and three attribute values for each attribute, one of ordinary skill in the art will recognize that such quantities are merely exemplary and any number of identified attributes and available product choices may be analyzed for market data and reflected in the output structure of the data segmenting tool.

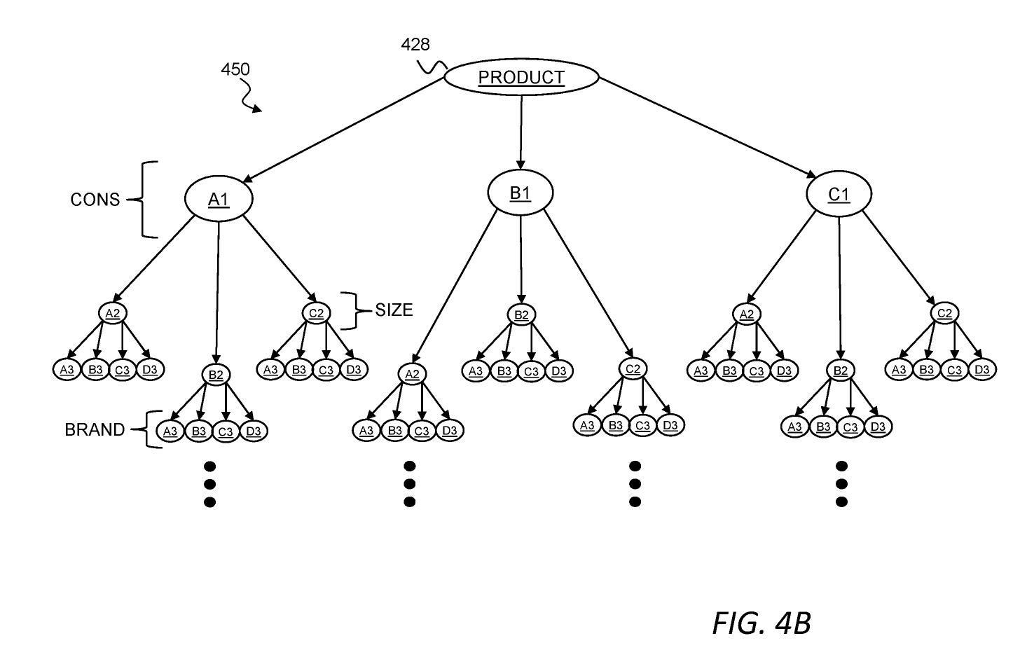

FIG. 5 is a table 500 listing an exemplary unsegmented data set. In this example, the table 500 stores a data set for shirt purchases. The exemplary data set may include transactional data for twenty customers, all of which have made seventeen purchases of a shirt product that is associated with three attributes: a sleeve type, a primary color, and a secondary color. The unsegmented data set contained in the table 500 is used herein to provide an example of the methodology, operation and output structure of the data segmenting tool. In one aspect, the data segmenting tool may output a generational decision tree reflecting the ordered attribute choices made by consumers when purchasing a shirt. For purposes of illustration only, the transaction numbers, attribute choices, and attribute values have been simplified and arbitrarily chosen. One of ordinary skill in the art will recognize that the data segmenting tool may be configured and implemented to process significantly larger and more complex data sets.

The data segmenting tool may arrange the transaction data as shown in the table 500, e.g., using columns for a customer identifier (CUST ID) 502, a number of transactions (NUM TXN) 504, a sleeve 506, a primary color (PRI. COLOR) 508, and a secondary color (SEC. COLOR) 510. One skilled in the art will recognize that the table 500 is a contiguous table and is depicted in FIG. 5 as two sections for presentation purposes only.

The CUST ID column 502 may reflect the unique identifier associated with a consumer. As shown in the table 500, multiple entries may be found for a given CUST ID (CUST ID 3, for example) indicating different product purchases. That is, one row 520 of the table 500 indicates CUST ID 3 made three purchases of a product having attributes S1, b, r. Another row 522 indicates CUST ID 3 also made fourteen purchases of a product having attributes S1, g, w. On the other hand, the data of table 500 shows in another row 524 that CUST ID 17 made all seventeen of its purchases of the same product having attributes S1, w, w. As described in more detail below, the S1, b, r, g and w values represent certain values for the attributes available to the consumer when purchasing a shirt.

The SLEEVE column 506 of the table 500 may include entries for three types of sleeves available for purchase in the current example. ‘S1’ may be indicative of a long-sleeve shirt, ‘S2’ may be indicative of a short-sleeve shirt, and ‘S3’ may be indicative of a no-sleeve or sleeveless shirt, such as a tank-top, tube-top, halter top or the like. The PRI. COLOR column 508 of the table 500 may reflect the available primary (or predominant) color of the shirts available for purchase. In the present example, the number of available primary colors may be limited, for simplicity, to four colors, b:blue; g:green; r:red; and w:white, although any number of colors may usefully be identified and analyzed using the techniques described herein. Similarly, the data listed in the SEC. COLOR column 510 of the table 500 may reflect a secondary (non-dominant or accent) color of the shirt. Also for simplicity of the present example, the choices available for secondary colors of a shirt may be limited to three, b:blue; r:red, w:white. According to the exemplary data given in the table 500, CUST ID 3, discussed above, purchased three shirts that were long-sleeve, primarily blue with red secondary colors. CUST ID 3, also according to the raw data of the table 500, purchased fourteen long-sleeve shirts that were primarily green with blue secondary colors. CUST ID 17, by contrast, purchased seventeen long-sleeve shirts that were predominantly white, with white secondary colors.

The raw data included in the table 500 yields some information about the types and numbers of shirts purchased, however there is no indication of which features of the shirts, if any, are more or less important to consumers. The data does not indicate if sleeve-type was a driver in the selection of the shirt or whether the impetus for shirt purchases was a primary or secondary color. Using the raw data from the table 500, the data segmenting tool may analyze the transactions, the attributes, and the attribute values to determine the significance of each attribute and further determine the relevance and order in which consumers consider each attribute when purchasing a shirt.

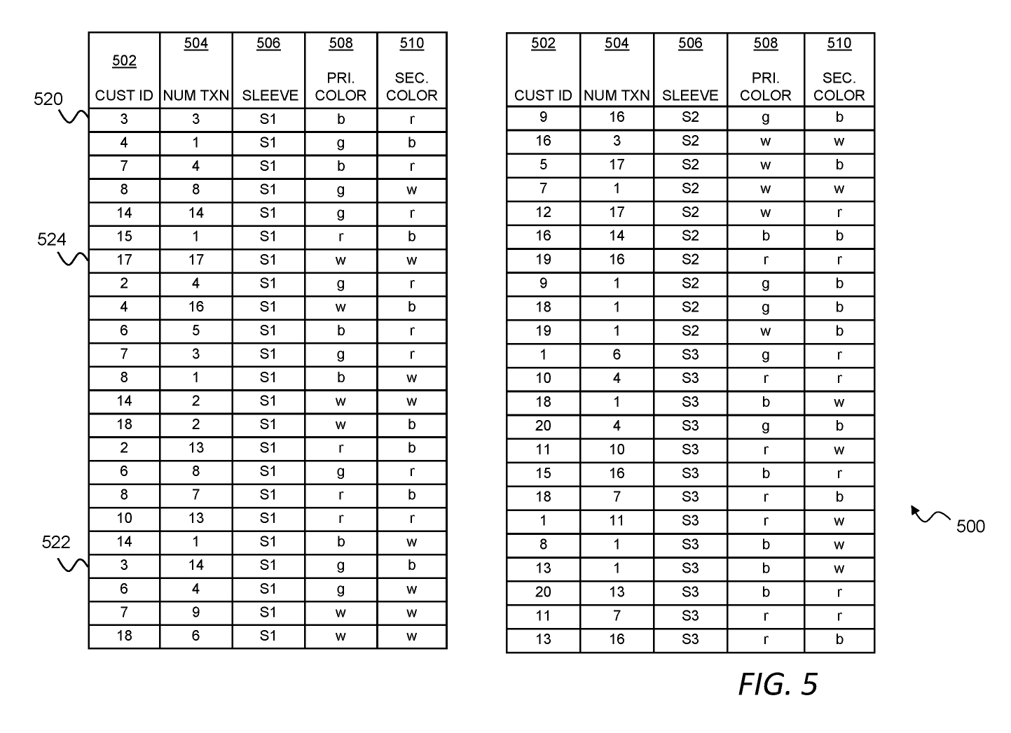

FIGS. 6A, 6B and 6C are tables listing a segmented data set. A data segmenting tool may generate or receive raw data, like that of the table 500 in FIG. 5, and re-orient the data according to the customer ID (CUST ID). Re-orienting the data by customer ID as described herein yields separate data sets for each attribute. FIG. 6A shows the re-oriented data 600 for the SLEEVE attribute, while FIG. 6B shows the re-oriented data 650 for PRI. COLOR and FIG. 6C shows the re-oriented data 660 for SEC. COLOR.

The data segmenting tool may re-orient the data sets for each attribute and model each of the re-oriented data sets according to a DM distribution, as described in detail above. The data segmenting tool may further calculate the empirical switching constants k_{we} for each attribute. For example, using the dirmult package of the R-System, the data segmenting tool may input, individually, the tables of FIGS. 6A, 6B and 6C into the weirMoM function, with the output reflecting the overdispersion (θ) or non-randomness of the DM distribution for the attribute data. The empirical switching constant k_{we} may be found by taking (k_{we}=1−θ).

For example, the output of the weirMoM function may calculate an overdispersion (θ) and an empirical switching constants k_{we} for each of the product attributes as:

| | Overdispersion | Empirical Switching |
|---|---|---|
| Attribute | (θ) | Constant (k_{we}) |
| SLEEVE | 0.9016922 | 0.0983078 |
| PM. COLOR | 0.6756932 | 0.3243068 |
| SEC. COLOR | 0.6292752 | 0.3707248 |

According to the data segmenting tool's analysis, in the given example, the SLEEVE attribute yields the lowest empirical switching constant k_{we}=0.0983078. Once the data segmenting tool has determined the attribute with the lowest empirical switching constant k_{we}, the tool may determine if a stopping condition has been met. In one aspect, the stopping condition may be met when a predetermined number of attributes have been investigated. Alternatively, the data segmenting tool may determine if the attribute identified as the attribute associated with the lowest empirical switching constant k_{we} is statistically significant. If the data segmenting tool determines that the attribute is significant, child nodes may be added to the generational tree and populated with transactions having a common value for the attributed. The significant attribute data may then be removed from the data set and the process can continue iteratively for each remaining attribute choice until the data segmenting tool determines a subsequent attribute is non-significant.

The significance of a given attribute for purposes of identifying a stopping point or condition may be determined by comparing the empirical switching constant k_{we} to a distribution of randomized switching constants k_{wr} calculated under a null-hypothesis (i.e., a number of randomly shuffled values) of the attribute being investigate. For example, the values for the SLEEVE attribute may be shuffled randomly a predetermined number of times, such as ten times. This operation may generate ten shuffled versions of the data for the SLEEVE attribute, which may be reflected in a shuffle matrix, for example as described below.

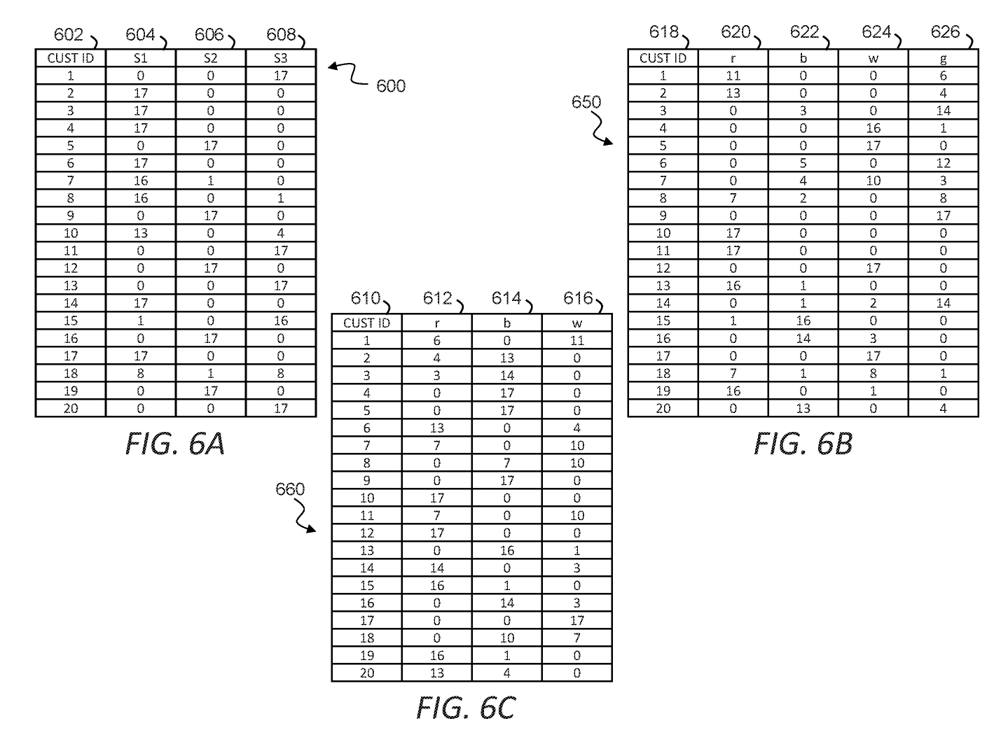

FIG. 7 is a table 700 reflecting a shuffle matrix. The data segmenting tool may generate the shuffle matrix 700 using the ten randomly shuffled data sets for the SLEEVE attribute as described above. The table 700 may include columns for the CUST ID 702, NUM TXN 704, SLEEVE 706, and the ten versions V1-V10 of randomly shuffled attribute values 708. The data segmenting tool may calculate the overdispersion (θ) and the randomized switching constants k_{wr} for each of the ten randomized data sets using the same methodology as finding the empirical switching constants k_{we} described above, beginning with selecting a randomized data set and re-orienting the data according to the CUST ID.

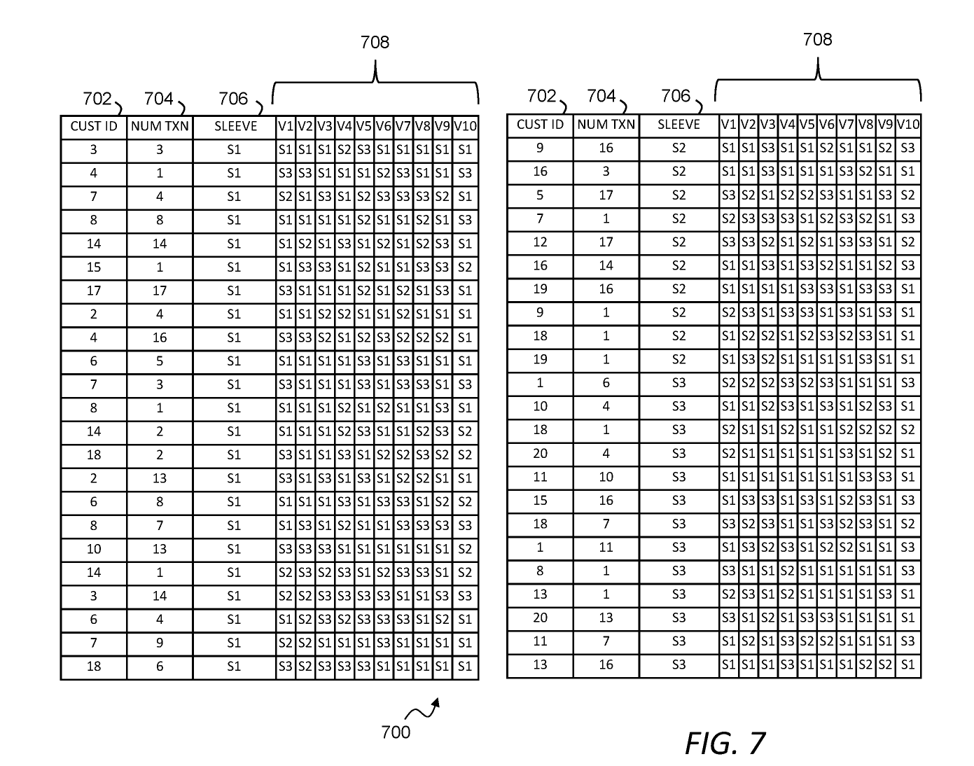

FIG. 8 is a table 800 listing an oriented data set for a randomized data set. The table 800 reflects the reoriented data, by CUST ID, for the randomized data set ‘V1’ from the table 700 of FIG. 7. In one aspect, the data segmenting tool may use the data from table 800 with the weirMoM function of the dirmult package for the R-system to calculate the overdispersion (θ) and the randomized switching constant k_{wr} for the randomized data set ‘V1’. The process may be repeated for all ten randomized data sets, generating a distribution of ten randomized switching constants k_{wr}. From the table 800, the ten randomized switching constants k_{wr} for the data sets ‘V1’-′V10′, respectively, may be calculated as follows:

k_{wr}=0.2395947(V1),0.3192615(V2),0.2372528(V3),0.3543631(V4),0.3659072(V5),0.3463048(V6),0.2632278(V7),0.2907203(V8),0.3177840(V9),0.2867494(V10)

The data segmenting tool may determine the mean of the distribution of the randomized switching constants k_{wr} as μ=0.302117 with a standard deviation of σ=0.046291.

This randomized result can provide a useful metric for identifying non-random purchasing decisions in transactional data. In one aspect, the data segmenting tool may compare the empirical switching constant k_{we} for the original data to the mean of the distribution of the randomized switching constants k_{wr} for the shuffled or randomized data sets. If the empirical switching constant k_{we} is within a predetermined multiple of the standard deviation from mean of the randomized switching constants k_{wr}, then the stopping condition may be met and the generational tree may be ended. For example, the data segmenting tool may determine that if the empirical switching constant k_{we} is within two times the standard deviation of the mean from the randomized switching constants k_{wr}, then the stopping condition may be met. In such a case, if the data segmenting tool's first iteration of the data indicates the empirical switching constant k_{we} is within a predetermined multiple of the standard deviation from mean of the randomized switching constants k_{wr}, this permits a statistically-based inference that for this data set, no attribute is more significant than the others (i.e., the choice for the attribute with the lowest empirical switching constant k_{we} is essentially random). As such, the data segmenting tool may not output a generational decision tree, or may reach a stopping condition for further subdivision of the data into sub-data sets. Alternatively, where the data set is the initial data set, the data segmenting tool may generate a generational decision tree of a single node “SHIRT,” if desired.

If, however the empirical switching constant k_{we} differs from the mean of the randomized switching constants k_{wr} by more than two times the standard deviation then a statistically-based inference may be reached that the current attribute(s) affect purchasing decisions, e.g., that the purchasing decisions are not random for this data set. Thus, a stopping condition may not be met and the segmentation process may continue to the next attribute as a subsequent generation. In the present example, as detailed above, the data segmenting tool may calculate the empirical switching constant k_{we} for the SLEEVE attribute to be k_{we}=0.0983078. The mean of the randomized switching constant k_{wr} distribution may be calculated as μ=0.302117, with a standard deviation of σ=0.046291. The data segmenting tool may determine that because the empirical switching constant k_{we} for the SLEEVE attribute differs from the mean of the randomized switching constants k_{wr} by more than two times the standard deviation, the segmentation is incomplete and should continue with new child nodes in the generational decision tree. That is:

μ−(2σ)>k_{we}; or

0.302117−(2*0.046291)>0.0983078.

As the empirical switching constant k_{we} is well below what would be expected from a random distribution, child nodes reflecting the attribute choices for the SLEEVE attribute may be added to the generational decision tree and the segmenting process will continue.

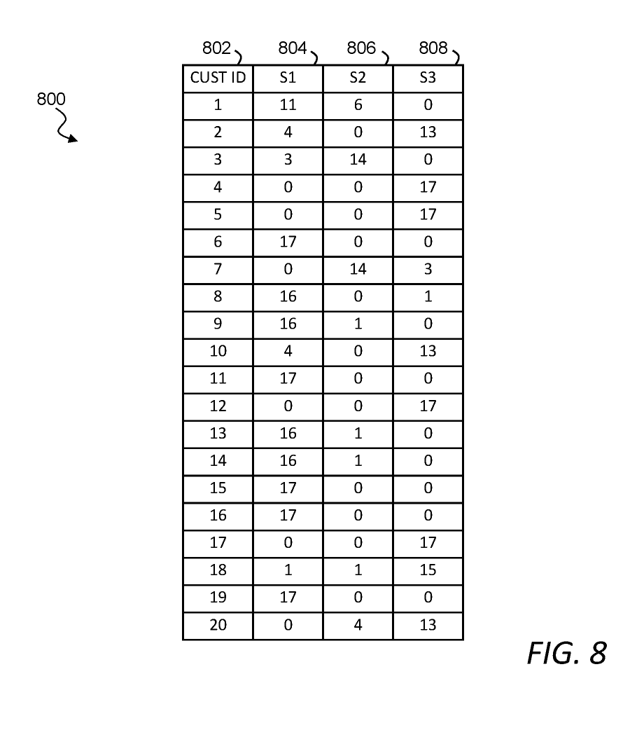

FIG. 9 is a generational decision tree 900. In the illustrated generational decision tree 900, the product (SHIRT) 902 is the originating node reflecting the product type being investigated. The data segmenting tool may determine, as detailed above, that the stopping condition has not been met after the analysis of the first attribute (SLEEVE). As such, the SLEEVE attribute may be added as a generation 904 to the generational decision tree 900. The generation 904 may be reflected as nodes for each of the attribute choices or possible values for the first attribute, namely ‘S1’ (long sleeve), S2′ (short sleeve), and S3′ (no sleeve).

In one aspect, because the stopping condition has not been met, the data segmenting tool may continue to analyze the data in an iterative process. The attribute choices for the first generation 904, ‘S1’, S2′, and S3′, may be investigated individually. Beginning with the ‘S1’ attribute, the tool may generate an associated sub-data set in which the recorded transactions having the ‘S1’ attribute choice for SLEEVE are investigated. Each sub-data set may then be reoriented an analyzed as described herein.

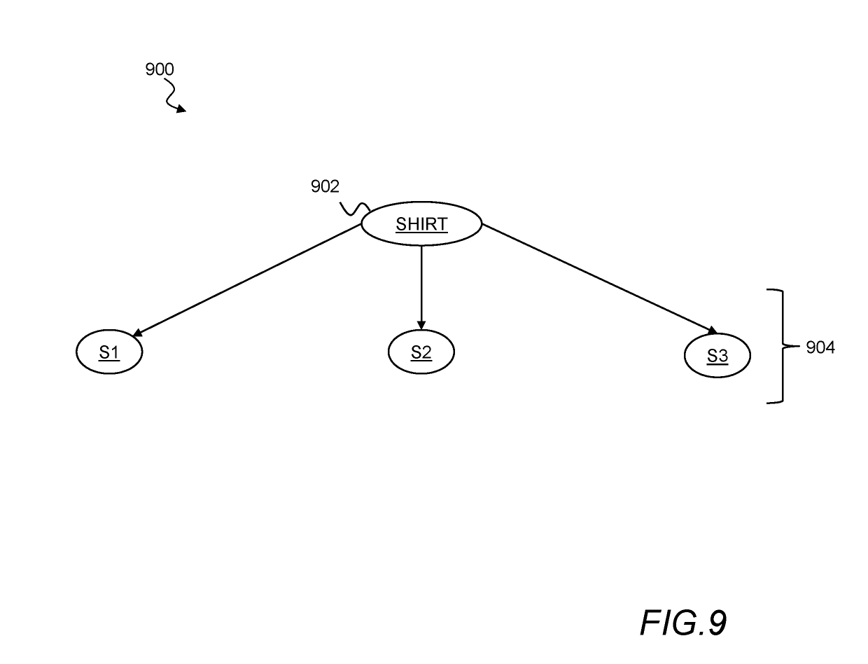

FIG. 10 is a table 1000 listing an exemplary unsegmented sub-data set. The sub-data shown in the table 1000 may, for example, include the transactions in which ‘S1’ was chosen. Because all of the entries in the table 1000 included the attribute ‘S1’, that column is not necessary to the table. The table 1000 may include columns for the CUST ID 1002, the NUM TXN 1004 (number of transactions), the PRI. COLOR 1006 (primary color) and the SEC. COLOR 1008 (secondary color). The data segmenting tool may restart the iterative analysis by re-orienting the data of this new sub-data set according to the CUST ID 1002.

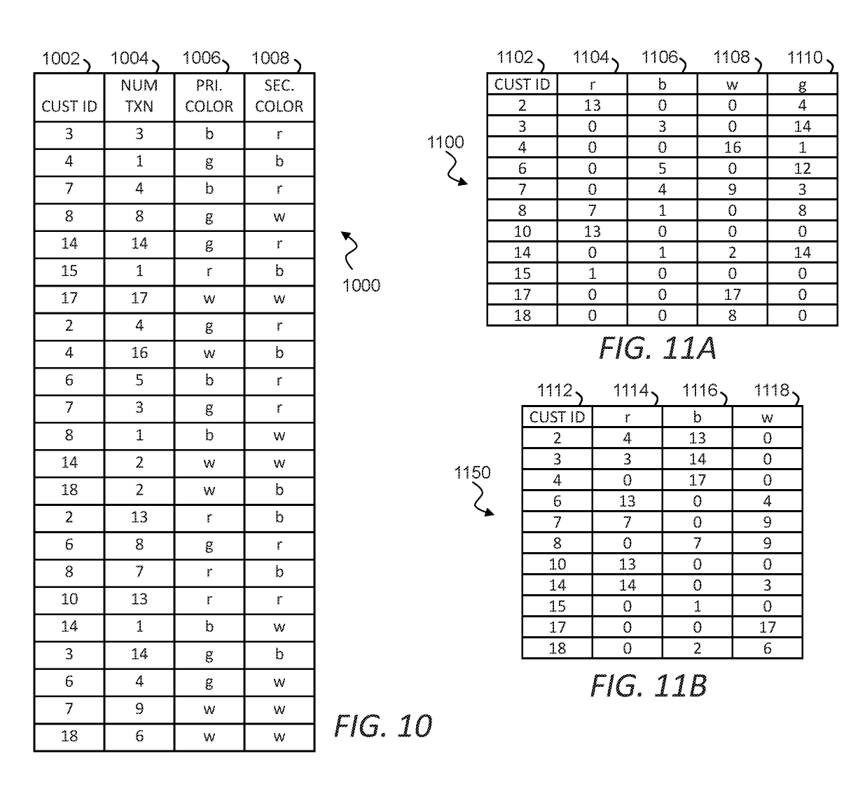

FIGS. 11A and 11B are tables 1100, 1150 listing oriented data sets. The data segmenting tool may reorient the sub-data set into separate reoriented data sets for each remaining attribute, with a row for each unique customer. The table 1100 of FIG. 11A reflects the reoriented data set for the PRI. COLOR attribute including a row for each unique customer (as identified in the column for the CUST ID 1102) and columns for the four attribute choices 1104, ‘b’ 1106, ‘w’ 1108, and ‘g’ 1110. The table 1150 of FIG. 11B reflects the reoriented data set for the SEC. COLOR attribute including columns for the three attribute choices ‘r’ 1114, ‘b’ 1116, and ‘w’ 1118.

The data segmenting tool may model the data from each of the tables 1100, 1150 according to a DM distribution and calculate the overdispersion (θ) and the empirical switching constant k_{we} for each attribute. The data segmenting tool may, for example, implement the weirMoM function of the dirmult package for the R-system to calculate the overdispersion (θ) and the empirical switching constant k_{we} as:

| | Overdispersion | Empirical Switching |
|---|---|---|
| Attribute | (θ) | Constant (k_{w}) |
| PM. COLOR | 0.6020352 | 0.3979648 |
| SEC. COLOR | 0.6037294 | 0.3962706 |

Based on the foregoing, the data segmenting tool may determine that the SEC. COLOR has the lowest empirical switching constant k_{we} of the two remaining attributes. In order to determine if this attribute is statistically significant to an ordered decision-making process, the result may be compared to the mean of a distribution of randomized switching constants k_{wr} calculated under a null-hypothesis (e.g., for data sets of randomly shuffled purchasing decisions). The data segmenting tool may generate a predetermined number of randomly shuffled data sets, ten for example, for the values of the SEC. COLOR attribute and, using the weirMoM function, determine the distribution of the randomized switching constants k_{wr}.

In an example calculation, the results may be k_{wr}=0.396271, 0.319017, 0.307669, 0.316842, 0.306349, 0.307784, 0.37543, 0.456937, 0.322274, 0.291616. Using these values, the data segmenting tool may further calculate the mean of the distribution of the randomized switching constants k_{wr} as: μ=0.3400191 with a standard deviation of σ=0.0526450. The data segmenting tool may then compare the mean of the distribution of the randomized switching constants k_{wr}, μ=0.340019, to the empirical switching constant k_{we}=0.3962706 for the SEC. COLOR and determine that the two values do not differ by more than twice the standard deviation of the distribution of the randomized switching constants k_{wr} (2σ=0.10529). Therefore, in this example, the data segmenting tool may determine that the stopping condition for the ‘S1’ child node of the SLEEVE attribute has been met and no further child nodes need to be added to the generational decision tree for that attribute choice. In terms of a physical interpretation of this result, the similarity of the mean randomized switching constant k_{wr} to the empirical switching constant k_{we} implies that a consumer decision among corresponding attribute values is effectively random, and that the attribute does not, as such, contribute meaningfully to a purchasing decision.

The data segmenting tool may perform the same analysis for the data associated with the other attribute choices ‘S2’ and ‘S3’, using the same methodology for the data associated with each attribute choice. The data segmenting tool may determine that the stopping condition is met for both ‘S2’ and ‘S3’ after processing the data associated with each attribute choice. For the exemplary data set collected on shirt purchases, the final output structure may be reflected by the generational decision tree depicted in FIG. 9. That is, the most significant attribute, and in this case, the only significant attribute to consumers when purchasing a shirt may be the sleeve type (i.e., the choice of a long-sleeve, short-sleeve, or no-sleeve shirt).

While the previous example described the data segmenting tool meeting a stopping condition when the attribute being presently investigated was not statistically significant, aspects of the data segmenting tool may be configured to consider other stopping conditions. For example, and using the same data set from the table 500 in FIG. 5, the data segmenting tool may be configured to determine a generational decision tree spanning three generations. That is, the stopping condition may be met when the data segmenting tool has mapped three levels of child nodes. In such a case, and using the same data set as above, the data segmenting tool may proceed through the iterative segmenting process in the manner described above for all attributes and attribute choices. The data segmenting tool, under those conditions, may generate an output structure that is larger and more complex. In another aspect, the stopping condition may yield different depths of the tree for different attribute values. For example, where a large portion (e.g. >95%) of the data is associated with one attribute value, there may be sufficient data in the corresponding sub-set (or a sub-set of that sub-set) to yield statistically significant results for further attribute subdivisions, whereas the smaller sub-set may not.

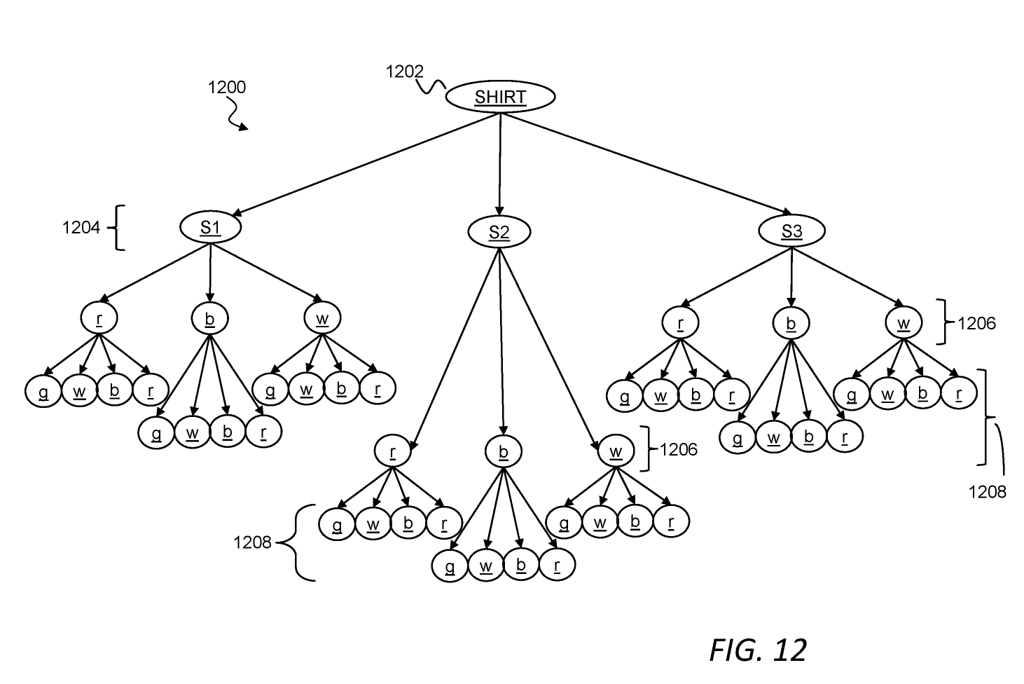

FIG. 12 is a generational decision tree 1200. The generational decision tree 1200 may include the product type 1202 ‘SHIRT’ as a first generation 1204 with child nodes for the SLEEVE attribute choices ‘S1’, ‘S2’, and ‘S3’. As with the previous example, the SLEEVE attribute may be found to have the lowest empirical switching constant k_{we}. A second iteration of data analysis may determine the SEC. COLOR attribute is more significant than the PRI. COLOR attribute (e.g., where the DM distribution of the SEC. COLOR attribute data yielded a lower empirical switching constant k_{we} than that of the DM distribution for the PRI. COLOR attribute data). The data segmenting tool may reflect that determination by generating a second generation 1206 of the generational decision tree 1200 with child nodes for the SEC. COLOR attribute choices ‘r’, and ‘w’. Either by default with only three attributes under investigation, or by additional iterative processing, the data segmenting tool may identify the PRI. COLOR attribute as the third attribute choice by generating a third generation 1208 with child nodes for each attribute value ‘g’, ‘w’, ‘b’, and ‘r’.

The generational decision tree 1200 reflects the full analysis of the raw data set of the table 500 of FIG. 5 in which a stopping condition was set to a predetermined number of levels. As detailed above, the stopping conditions described herein are exemplary. While a predetermined number of levels may be used, and/or an empirical switching constant k_{we} within two times the standard deviation of the mean of randomized switching constants k_{wr} for shuffled data sets as described above, one of ordinary skill in the art will recognize that other thresholds may be implemented without deviating from the scope of the invention. For example, the stopping condition may include a predetermined number of subdivisions, or a minimum data size for sub-data sets, or any other stopping condition or combination of stopping conditions usefully for determine when further processing is unlikely to yield further useful information about the market structure or the effect of attributes on consumer purchasing decisions.

In general, the methods described above may be realized as a computer program product embodied in a non-transitory computer readable medium that, when executing on a computer, performs some or all of the steps described above. In another aspect, a computer may be configured to perform the steps described herein. In this latter case, there is disclosed herein a system comprising a memory storing panel data characterizing purchasing behavior of a predetermined group of consumers in a panel, audit data characterizing product displays at a number of retail location, wherein the purchasing behavior identifies retail venues by store name but not by geographic location, trade area data and demographic attributes for the predetermined group of consumers in the panel. The system may further include a processor configured to create a consumer response model by relating one or more independent variables including the one or more display attributes to a dependent variable based on a trip outcome, wherein a set of trip outcomes is linked to geographic locations of the retail venues for each one of the set of trip outcomes based on a geographic relationship between a home location of a corresponding one of the predetermined group of consumers and a number of geographic locations of a corresponding number of stores for the retail venue, the processor further configured to scale the consumer response model to a trade area based on a relationship between the trade area data and demographic attributes for the predetermined group of consumers in the panel, thereby providing a trade area consumer response model including the one or more independent variables and the dependent variable. The system may further include a physical display device coupled to the processor and configured by the processor to present a user interface for applying the consumer response model to estimate the trip outcome for the trade area based on the one or more display attributes.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, R, SAS, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method comprising:
generating a first data set comprising market data, the market data describing transactions in each of a plurality of products, each product being characterized by a number of attributes having a corresponding number of values;
orienting the data set into oriented data sets each having a common attribute selected from the number of attributes;
fitting each of the oriented data sets to a Dirichlet multinomial distribution;
for each of the oriented data sets, calculating an empirical switching constant based on the Dirichlet multinomial distribution, each empirical switching constant indicative of a significance of one of the number of attributes in a consumer decision relating to a purchase of one of the plurality of products; and
selecting a first attribute from the number of attributes having a lowest switching constant; and
segmenting the market data into child nodes using the first attribute associated with the lowest switching constant,
generating sub-data sets for each child node, each sub-data set characterized by a common value of the first attribute; and
iteratively performing the steps of orienting, fitting, calculating, selecting, and generating until a stopping condition is met.

2. The method of claim 1, further comprising:
after selecting the first attribute, randomly permuting the values of the first attribute in the data set a predetermined number of times, thereby producing a pre-determined number of attribute-randomized data sets;
calculating a randomized switching constant of the first attribute for each of the attribute-randomized data sets, thereby producing a randomized switching constant distribution; and
identifying a mean of the randomized switching constant distribution and a standard deviation of the randomized switching constant distribution,
wherein the stopping condition occurs when the lowest empirical switching constant is within the mean of the randomized switching constant distribution by at least a predetermined multiple of the standard deviation of the randomized switching constant distribution.

3. The method of claim 2, wherein the predetermined multiple equals two.

4. The method of claim 2, wherein the predetermined number of times the values of the first attribute in the data set are permuted is ten.

5. The method of claim 1, wherein the stopping condition occurs when the market data has been segmented into a predetermined number of attributes.

6. The method of claim 1, wherein calculating the empirical switching constant comprises using an estimation technique based on attributes of the Dirichlet multinomial distribution.

7. The method of claim 6, wherein the estimation technique employs a maximum likelihood estimation.

8. The method of claim 6, wherein the estimation technique employs a method of moments estimation.

9. The method of claim 6, wherein the estimation technique includes calculation of a covariance matrix for at least one of the attributes of the Dirichlet multinomial distribution.

10. The method of claim 6, wherein the estimation technique includes evaluation of an overdispersion within the Dirichlet multinomial distribution.

11. The method of claim 1, wherein the data set is generated from panel data including a number of purchase records reported by a number of consumers in a panel for a number of shopping trips.

12. The method of claim 1, wherein the data set is generated from a loyalty program for a retailer.

13. The method of claim 1, further comprising generating an output structure reflecting the segmented market data.

14. The method of claim 13, wherein the output structure comprises a generational decisions tree.

15. The method of claim 13, wherein generating the output structure comprises a print command.

16. A computer program product comprising computer executable code embodied in a nontransitory computer readable medium that, when executing on one or more computing devices, performs the steps of:
a) generating a first data set comprising market data, the market data describing transactions in each of a plurality of products, each product being characterized by a number of attributes having a corresponding number of values;
b) orienting the data set into oriented data sets each having a common attribute selected from the number of attributes;
c) fitting each of the oriented data sets to a Dirichlet multinomial distribution;
d) for each of the oriented data sets, calculating an empirical switching constant based on the Dirichlet multinomial distribution, each empirical switching constant indicative of a significance of one of the number of attributes in a consumer decision relating to a purchase of one of the plurality of products; and
e) selecting a first attribute from the number of attributes having a lowest switching constant; and
f) segmenting the market data into child nodes using the first attribute associated with the lowest switching constant,
g) generating sub-data sets for each child node, each sub-data set characterized by a common value of the first attribute; and
h) iteratively performing steps b)-g) on the sub-data sets until a stopping condition is met.

17. A system comprising:
a memory storing a data set comprising market data, the market data describing transaction volumes of a plurality of products, each product being characterized by a plurality of attributes having corresponding values; and
a processor configured to:
a) generate a first data set comprising market data, the market data describing transactions in each of a plurality of products, each product being characterized by a number of attributes having a corresponding number of values;
b) orient the data set into oriented data sets each having a common attribute selected from the number of attributes;
c) fit each of the oriented data sets to a Dirichlet multinomial distribution;
d) for each of the oriented data sets, calculate an empirical switching constant based on the Dirichlet multinomial distribution, each empirical switching constant indicative of a significance of one of the number of attributes in a consumer decision relating to a purchase of one of the plurality of products; and
e) select a first attribute from the number of attributes having a lowest switching constant; and
f) segment the market data into child nodes using the first attribute associated with the lowest switching constant,
g) generate sub-data sets for each child node, each sub-data set characterized by a common value of the first attribute; and
h) iteratively perform steps b)-g) on the sub-data sets until a stopping condition is met.
